(19) United States
(12) Patent Application Publication
(10) Pub. No.: US 2006/0101418 A1
(43) Pub. Date: May 11, 2006

(54) Apparatus and method for automatic generation of event profiles in an integrated development environment

(75) Inventors: Eric Lawrence Barsness, Pine Island, MN (US); John Matthew Santosuosso, Rochester, MN (US)

Correspondence Address: MARTIN & ASSOCIATES, LLC, P.O. BOX 548, CARTHAGE, MO, 64836-0548, US

(73) Assignee: INTERNATIONAL BUSINESS MACHINES CORPORATION, ARMONK, NY (US)

(21) Appl. No.: 10/970,412

(22) Filed: Oct. 21, 2004

(51) Int. Cl. G06F 9/44

(52) U.S. Cl. 717/130; 717/111

(57) ABSTRACT

An apparatus and method automatically generate an event profile in an integrated development environment. In one specific implementation, an event profile is automatically created that identifies portions of the computer program that have changed since the last time the computer program was run. The automatically-generated event profile may be used by a profiler to generate a trace of the computer program. By automatically creating the event profile based on the code that changed, the code developer is relieved of the burden of manually creating many event profiles.

### BACKGROUND OF THE INVENTION

1. Technical Field

This invention generally relates to computer systems, and more specifically relates to apparatus and methods for developing computer programs.

2. Background Art

Computer systems typically include a combination of hardware, such as semiconductors and circuit boards, and software, also known as computer programs. As advances in semiconductor processing and computer architecture push the performance of the computer hardware higher, more sophisticated computer software has evolved to take advantage of the higher performance of the hardware, resulting in computer systems today that are much more powerful than just a few years ago.

As the sophistication and complexity of computer software increase, the more difficult the software is to debug. Debugging is the process of finding problems, or “bugs”, during the development of a computer program. In addition to finding errors in the code, a code developer may also want to perform run-time tests on the computer program to see if it meets defined performance goals. Such run-time testing of a computer program is typically done using a tool known in the art as a profiler. A profiler typically inserts code known as instrumentation hooks into a computer program to log when that portion of the computer program is executed. It is common, for example, for instrumentation hooks to be placed at all entry and exit points in the computer program. Once the instrumentation hooks are in place, the computer program is executed, and the instrumentation hooks create an output known as a “trace”. With a computer program of any complexity at all, instrumenting all entry and exit points in the computer program results in a huge trace. The code developer must then wade through this huge amount of data in search for the performance problem. This is a prime example of data overload, when the amount of data collected is so great that the code developer has little chance of locating anything of value.

Modern integrated development environments (IDEs) often include a profiler that allows comparing differences between executions of different versions of a computer program. Thus, the profiler may be run for a first version, the computer program may be changed to create a second version, the profiler may then be run for the second version, and the results of running the second version can then be compared to the results of running the first version. In this manner, performance problems may be identified during the development of a computer program.

The comparison of different versions of a computer program using a profiler is a highly manual process. The code developer typically must ponder exactly what he or she wants to trace, and what type of data to collect. To this end, tools such as the iSeries Performance Explorer (PEX) and jInsight developed by IBM Corporation have introduced filter capabilities so that not all entry and exit points are traced. The filters allow defining conditions that cause the profiler to only report what the code developer wants. For example, PEX now allows setting a filter on a method, class, or package level when tracing Java code. This can help the code developer from being swamped with unneeded trace records.

While filtering tools are useful, many problems still exist in using these tools. The primary problem is the manual effort required to define the filters in the first place. With the existing tools, the code developer must manually create each filter that is used by the profiler. Since performance analysis is an iterative process, this can cause the code developer to have to create dozens of filters as a performance problem is narrowed down. In some cases the code developer may create a filter that misses what was needed, which causes the code developer to have to go back and recreate the filter and run it again. Without a way to improve the known methods of profiling a computer program, the computer industry will continue to suffer from inefficient methods and tools for developing computer programs.

### DISCLOSURE OF INVENTION

According to the preferred embodiments, an apparatus and method automatically generate an event profile in an integrated development environment. In one specific implementation, an event profile is automatically created that identifies portions of the computer program that have changed since the last time the computer program was run. The automatically-generated event profile may be used by a profiler to generate a trace of the computer program. By automatically creating the event profile based on the code that changed, the code developer is relieved of the burden of manually creating many event profiles.

The foregoing and other features and advantages of the invention will be apparent from the following more particular description of preferred embodiments of the invention, as illustrated in the accompanying drawings.

### BRIEF DESCRIPTION OF DRAWINGS

The preferred embodiments of the present invention will hereinafter be described in conjunction with the appended drawings, where like designations denote like elements, and:

FIG. 1 is a block diagram of an apparatus in accordance with the preferred embodiments;

FIG. 2 is a block diagram of a prior art integrated development environment;

FIG. 3 is a flow diagram of a prior art method for a code developer to manually define and use event types and event filters shown in FIG. 2;

FIG. 4 is a block diagram of an integrated development environment in accordance with the preferred embodiments;

FIG. 5 is a display window in accordance with the preferred embodiments showing how a code developer may make selections that determine the function of the automatic event profile generation mechanism 124 shown in FIGS. 1 and 4; and

FIG. 6 is a flow diagram of a method for automatically generating event profiles in accordance with the preferred embodiments.

### BEST MODE FOR CARRYING OUT THE INVENTION

The present invention is used in a programming environment for developing computer programs. For those who are not familiar with software development techniques, the brief overview below provides background information that will help the reader to understand the present invention.

### 1. OVERVIEW

### Modern Programming Environments

Computer programs are constructed using one or more programming languages. Like words written in English, a programming language is used to write a series of statements that have particular meaning to the drafter (i.e., the programmer). The programmer first drafts a computer program in human readable form (called source code) prescribed by the programming language, resulting in a source code instruction (or statement) stream. The programmer then uses mechanisms that change the human readable form of the computer program into a form that can be understood by a computer system (called machine readable form, or object code). These mechanisms are typically called compilers; however, it should be understood that the term “compiler”, as used within this specification, generically refers to any mechanism that transforms one representation of a computer program into another representation of that program.

This machine readable form is a stream of binary instructions (i.e., ones and zeros) that make up operational codes (known as op codes) that are meaningful to the computer. The compiler typically compiles each human readable statement into one or more machine readable instructions. Compilers generally translate each human readable statement in the source code instruction stream into one or more intermediate language instructions, which are then converted into corresponding machine-readable instructions. Once the machine-readable instructions have been generated, the computer program may be run on the computer system it was designed for.

Modern programming environments may provide many different combinations of features. For example, most programming environments include an editor or browser that displays source code to the programmer on a display device. A compiler is used, as explained above, to generate machine code from source code. A linker may also be included to allow sub-portions of the program to be separately compiled and linked together after compilation. Some programming environments include target hardware, which is the hardware on which the computer program is intended to run. Others may provide a simulator in software to “run” the code to simulate how the target hardware would respond to the computer program. Most modern programming environments also provide a debugger to help a programmer to locate problems in a computer program.

### Integrated Development Environments

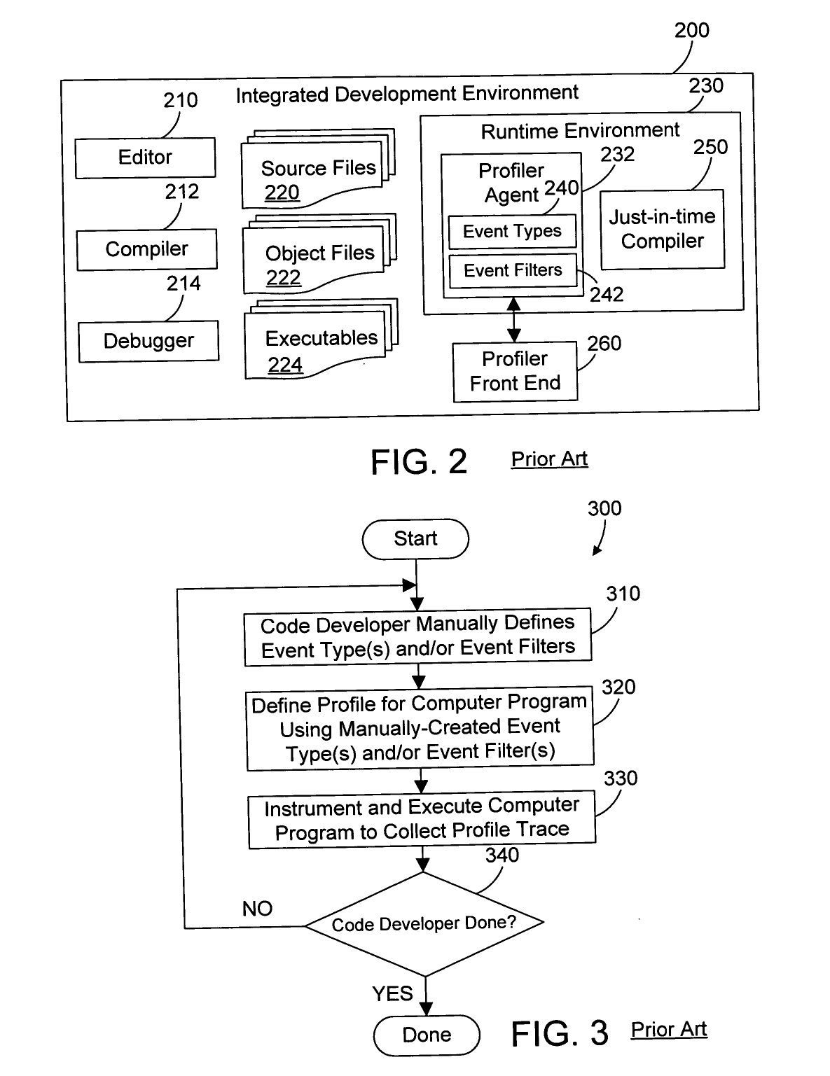

Modern programing environments known as “integrated development environments” (IDEs) have been developed that integrate different development tools into a single package. For example, referring to FIG. 2, a prior art integrated development environment 200 is shown that includes an editor 210, a compiler 212, a debugger 214, source files 220, object files 222, executables 224, and a run-time environment 230. Some known IDEs include an integrated runtime environment 230, while others use a runtime environment external to the IDE. For the example in FIG. 2, we assume that runtime environment 230 includes a profiler agent 232 and a just-in-time compiler 250. By integrating the runtime environment 230 into the integrated development environment 200, the IDE 200 provides a single tool to write code, compile code, and run code to see if it performs as expected.

### Profiling a Computer Program

Profilers have been developed to allow logging information from a computer program as it runs. Instrumentation code known as “hooks” are inserted into the computer program to log information to a “program trace”, which is a list of all events of interest to the programmer. The program trace is collected as the computer program runs, thereby allowing the detection of performance problems without stopping the execution of the computer program. The prior art runtime environment 230 in FIG. 2 includes a profiler agent 232 that collects the program trace as the computer program runs. The profiler agent 232 may include one or more event types 240, and/or one or more event filters 242. Event types and event filters serve to limit the trace information collected as the computer program runs so the code developer can focus the trace on potential performance problems in the code. An event type 240 may include a specification of certain types of events to profile, such as method calls, classes being loaded, etc. An event filter 242 may specify conditions that must be met for the event to be included in the trace. For example, an event filter may specify to only profile calls to three specified methods. The IDE 200 includes a profiler front end 260 that is coupled to the profiler agent 232 in the run-time environment 230. The profiler front end 260 allows the code developer (user) to manually define the event types 240 and the event filters 242. The profiler front end 260 also generally used to view the resulting trace data in a graphical manner, and allows the user to interact with the trace data (i.e., look at different levels of detail).

Referring to FIG. 3, a prior art method 300 for profiling a computer program allows the code developer to manually define one or more event types and/or one or more event filters (step 310). A profile is then defined to include one or more of the event types and/or event filters (step 320). Once the profile is defined, the computer program will have the instrumentation hooks inserted to collect the desired information, and the computer program is then executed to generate the program trace (step 330), as is known in the art. If the code developer wants to do more profiling (step 340=NO), control returns to step 310 and method 300 continues. When the code developer is done (step 340=YES), method 300 is done.

A key feature of the prior art is the manual generation of the event types 240 and event filters 242 by the code developer. For a computer program of any complexity, the effort to manually generate the event types 240 and event filters 242 is a very time-consuming and error-prone task. The manual generation of event types and event filters in the prior art is not an efficient way to debug performance problems in a computer program.

### 2.0 DETAILED DESCRIPTION

The preferred embodiments provide a way to automatically generate event profiles according to what edits have been made to a computer program. The changes made with the editor are tracked, and one or more event profiles are automatically generated according to the changes made. The code developer may then select from all the event profiles, which may include both manually-generated and automatically-generated event profiles, when deciding what to instrument in the computer program for the profiler. By automating the generation of event profiles according to the changed made using the editor, an integrated development environment of the preferred embodiments greatly simplifies the task of the code developer in profiling performance problems by reducing the number of manually-generated event profiles that need to be generated.

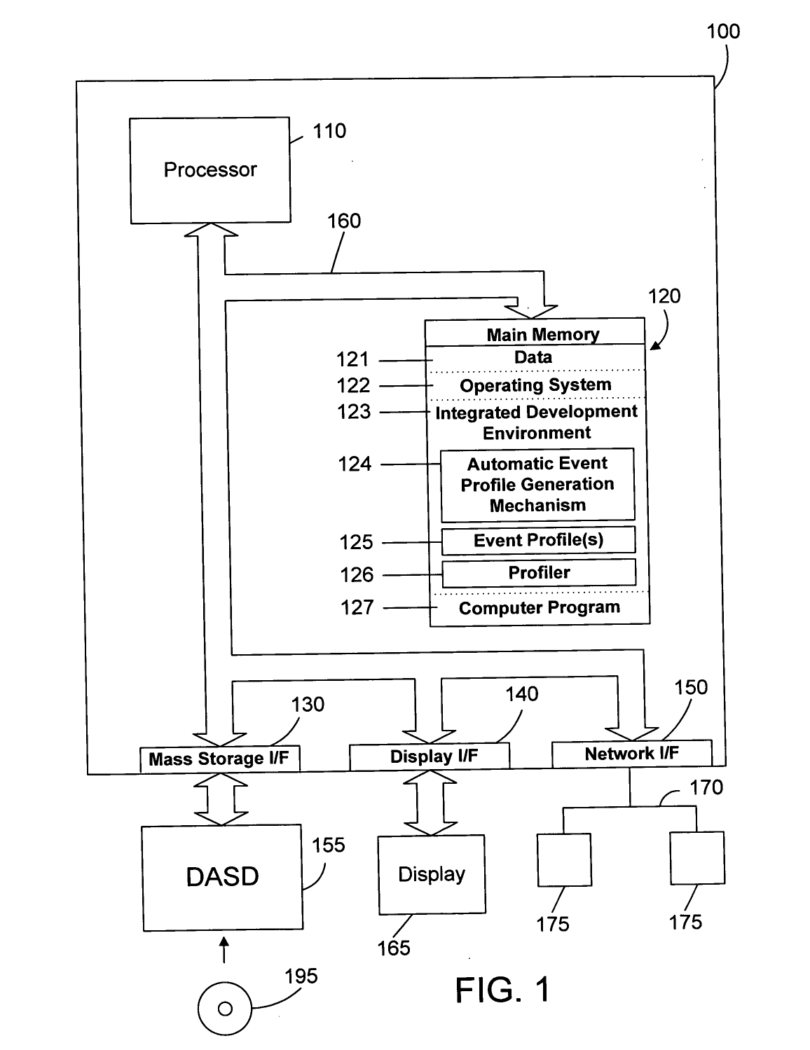

Referring now to FIG. 1, a computer system 100 is one suitable implementation of an apparatus in accordance with the preferred embodiments of the invention. Computer system 100 is an IBM eServer iSeries computer system. However, those skilled in the art will appreciate that the mechanisms and apparatus of the present invention apply equally to any computer system, regardless of whether the computer system is a complicated multi-user computing apparatus, a single user workstation, or an embedded control system. As shown in FIG. 1, computer system 100 comprises a processor 110, a main memory 120, a mass storage interface 130, a display interface 140, and a network interface 150. These system components are interconnected through the use of a system bus 160. Mass storage interface 130 is used to connect mass storage devices (such as a direct access storage device 155) to computer system 100. One specific type of direct access storage device 155 is a readable and writable CD RW drive, which may store data to and read data from a CD RW 195.

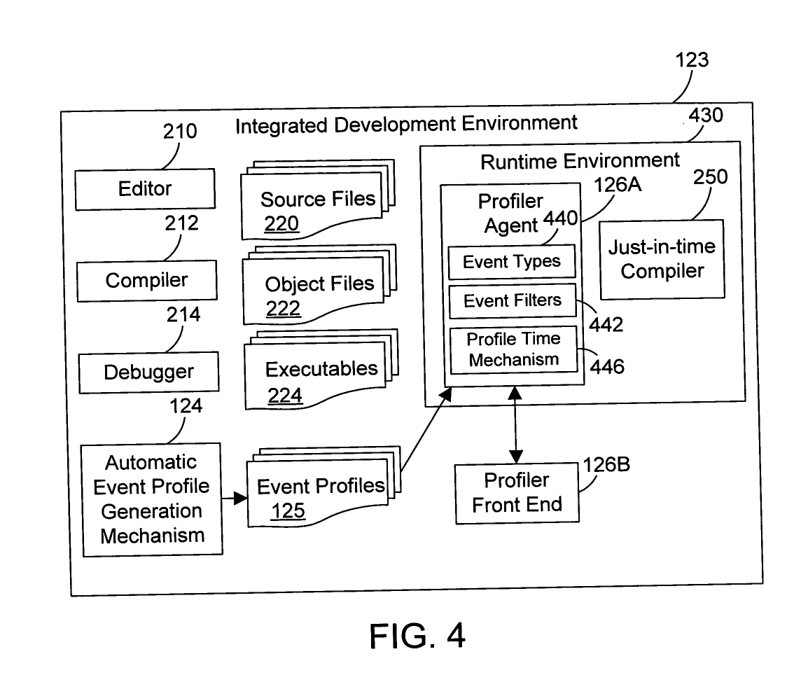

Main memory 120 in accordance with the preferred embodiments contains data 121, an operating system 122, an integrated development environment 123, and a computer program 127. Data 121 represents any data that serves as input to or output from any program in computer system 100. Operating system 122 is a multitasking operating system known in the industry as OS/400; however, those skilled in the art will appreciate that the spirit and scope of the present invention is not limited to any one operating system. Integrated development environment 123 is a computer program development environment that preferably integrates together the creation and debugging of a computer program, such as computer program 127. Note that integrated development environment 123 may include an editor, compiler, linker, and simulator that are not shown in FIG. 1 but that are known in the art to be part of integrated development environments. In the preferred embodiments, integrated development environment 123 includes an automatic event profile generation mechanism 124 that can automatically generate one or more event profiles 125 that may be used by a profiler 126. An event profile 125 as used herein can include event type specifications and event filters, as shown in FIG. 4 and discussed in more detail below. Computer program 127 is any suitable program that is being developed using integrated development environment 123.

Computer system 100 utilizes well known virtual addressing mechanisms that allow the programs of computer system 100 to behave as if they only have access to a large, single storage entity instead of access to multiple, smaller storage entities such as main memory 120 and DASD device 155. Therefore, while data 121, operating system 122, integrated development environment 123, and computer program 127 are shown to reside in main memory 120, those skilled in the art will recognize that these items are not necessarily all completely contained in main memory 120 at the same time. It should also be noted that the term “memory” is used herein to generically refer to the entire virtual memory of computer system 100, and may include the virtual memory of other computer systems coupled to computer system 100.

Processor 110 may be constructed from one or more microprocessors and/or integrated circuits. Processor 110 executes program instructions stored in main memory 120. Main memory 120 stores programs and data that processor 110 may access. When computer system 100 starts up, processor 110 initially executes the program instructions that make up operating system 122. Operating system 122 is a sophisticated program that manages the resources of computer system 100. Some of these resources are processor 110, main memory 120, mass storage interface 130, display interface 140, network interface 150, and system bus 160.

Although computer system 100 is shown to contain only a single processor and a single system bus, those skilled in the art will appreciate that the present invention may be practiced using a computer system that has multiple processors and/or multiple buses. In addition, the interfaces that are used in the preferred embodiment each include separate, fully programmed microprocessors that are used to off-load compute-intensive processing from processor 110. However, those skilled in the art will appreciate that the present invention applies equally to computer systems that simply use I/O adapters to perform similar functions.

Display interface 140 is used to directly connect one or more displays 165 to computer system 100. These displays 165, which may be non-intelligent (i.e., dumb) terminals or fully programmable workstations, are used to allow system administrators and users to communicate with computer system 100. Note, however, that while display interface 140 is provided to support communication with one or more displays 165, computer system 100 does not necessarily require a display 165, because all needed interaction with users and other processes may occur via network interface 150.

Network interface 150 is used to connect other computer systems and/or workstations (e.g., 175 in FIG. 1) to computer system 100 across a network 170. The present invention applies equally no matter how computer system 100 may be connected to other computer systems and/or workstations, regardless of whether the network connection 170 is made using present-day analog and/or digital techniques or via some networking mechanism of the future. In addition, many different network protocols can be used to implement a network. These protocols are specialized computer programs that allow computers to communicate across network 170. TCP/IP (Transmission Control Protocol/Internet Protocol) is an example of a suitable network protocol.

At this point, it is important to note that while the present invention has been and will continue to be described in the context of a fully functional computer system, those skilled in the art will appreciate that the present invention is capable of being distributed as a program product in a variety of forms, and that the present invention applies equally regardless of the particular type of signal bearing media used to actually carry out the distribution. Examples of suitable signal bearing media include: recordable type media such as floppy disks and CD RW (e.g., 195 of FIG. 1), and transmission type media such as digital and analog communications links.

Referring now to FIG. 4, an integrated development environment 123 of the preferred embodiments includes many of the items 210, 212, 214, 220, 222, 224 and 250 shown in the prior art IDE 200 shown in FIG. 2. In addition, the IDE 123 of the preferred embodiments also includes an automatic event profile generation mechanism 124 that can automatically generate one or more event profiles 125 according to changes made to a computer program using editor 210. The automatic event profile generation mechanism 124 monitors the changes to the computer program made by editor 210, then automatically generates one or more event profiles 125 based on what changed. The term “event profile” used herein includes any type of information that may be used by a profiler. Event profiles 125 expressly include event types 440 and event filters 442. Event types 440 and event filters 442 can be similar to the prior art event types 240 and event filters 242 in FIG. 2, but may also include the event profiles 125 that are automatically generated by the automatic event profile generation mechanism 124. In the preferred embodiments, event types 440 have two different aspects. The first is what type of event to collect, such as: method entry and exit; object create and delete; class load and unload; and object lock and unlock. The second aspect to event types 440 is the level at which to collect the event(s): method level, class level (all methods in a class), package level (all classes and methods in a package).

The profiler 126 in FIG. 1 is shown in FIG. 4 to have two different parts, namely the profiler agent 126A within the runtime environment 430 that is coupled to the profiler front end 126B. The profiler agent 126A may access the event profiles 125 that are automatically generated by the automatic event profile generation mechanism 124. A user using the profiler front end 126B may thus select among various event types 440 and event filters 442, which include event types and event filters in the automatically-generated event profiles 125, in addition to any manually-defined event types and event filters. The profiler agent 126A also includes a profile time mechanism 446 that tracks the time to execute the computer program each time it is run. The IDE 123 thus allows automatically tracking changes to the computer program, and determining from the profile time mechanism 446 whether those changes cause increased or decreased performance as measured by the profile time mechanism 446.

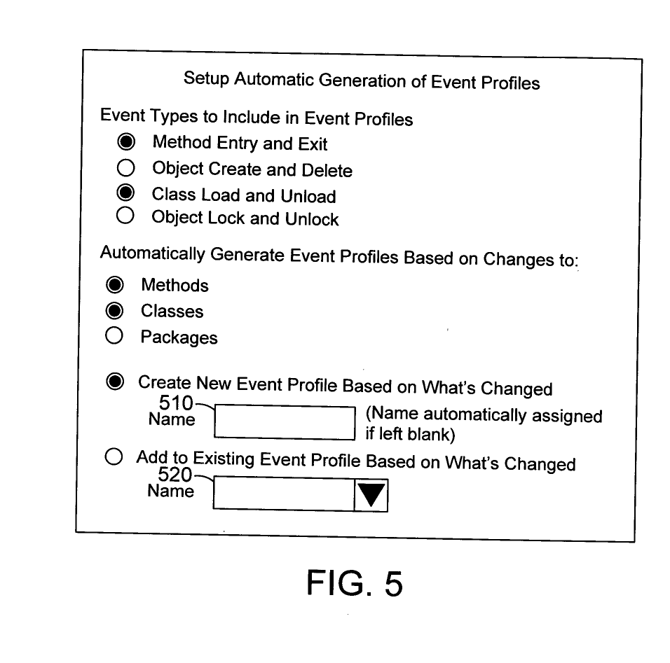

The automatic event profile generation mechanism 124 includes a user interface that allows the user (e.g., code developer) to determine the function of the event profile generation mechanism 124. One possible display screen for the user interface is shown in FIG. 5. The user may select which event types to include in the event profiles. In FIG. 5, the user may select between the following event types: method entry and exit; object create and delete; class load and unload; and object lock and unlock. Note that these selections are not mutually-exclusive, which means that more than one may be selected at a time. The selections in FIG. 5 include method entry and exit, and class load and unload. In addition, the user may select to automatically generate event profiles based on changes to methods, classes, or packages. Again, these selections are not mutually-exclusive, which means that more than one may be selected at a time. Thus, as shown in FIG. 5, both methods and classes may be selected, which will cause the automatic event profile generation mechanism 124 to generate event profiles based on changes to methods and classes. The user interface also allows the user to select whether the automatically-generated event profile is a new event profile, or whether it is added to an existing event profile. As shown in FIG. 5, a new event profile is created based on what's changed. Because no event profile name is specified in the name box 510, the automatic event profile generation mechanism 124 will automatically assign a name to the automatically-generated event profile. If the user wanted to add the automatically-generated event profile to an existing profile, the user could type the name of the existing profile into the name box 520, or could select from a drop-down list of existing event profiles. In this manner, the code developer may easily set user preferences to determine the function of the automatic event profile generation mechanism 124.

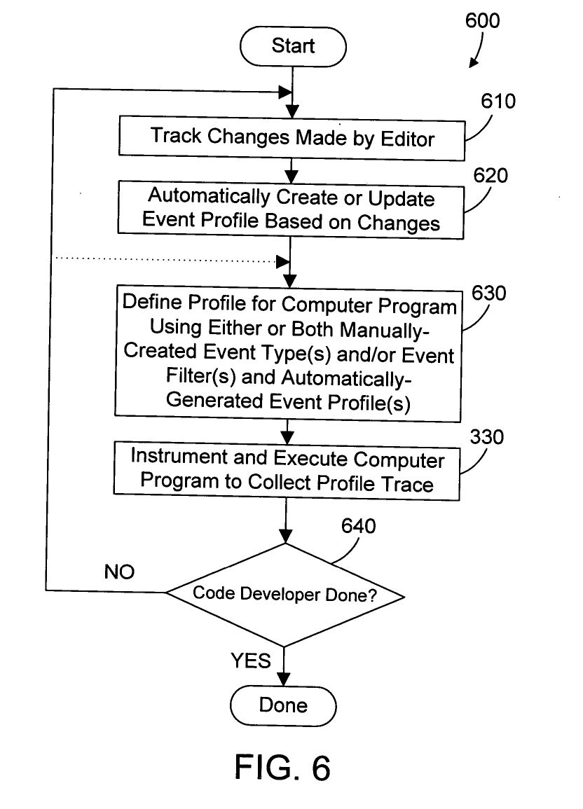

Referring now to FIG. 6, a method 600 in accordance with the preferred embodiments tracks changes made using the editor (step 610), automatically creates or updates an event profile based on the changes (step 620), and allows a user to define a profile for a computer program using either or both manually-created event types and/or event filters and automatically-generated event profiles (step 630). Once the profile is defined, the computer program may be instrumented and run (step 330), as known in the art. If the code developer has more profiling to do (step 640=NO), method 600 returns to step 610 or 630 and continues until the code developer is don't (step 640=YES).

While the runtime environment 430 shown in FIG. 4 is shown to reside within the IDE 123, one skilled in the art will recognize that the runtime environment 430 could be separate from IDE 123 as well. If the runtime environment 430 is separate from the IDE 123, the profiler agent 126A simply accesses the event profiles 125 that are automatically generated by the automatic event profile generation mechanism 124 in the IDE 123.

The preferred embodiments greatly enhance the ability of a code developer to measure the performance of a computer program through profiling. In addition to manual generation of event types and event filters to measure desired performance, the automatic event profile generation mechanism of the preferred embodiments can automatically generate one or more event profiles by tracking changes in the computer program made using the editor in the IDE.

One skilled in the art will appreciate that many variations are possible within the scope of the present invention. Thus, while the invention has been particularly shown and described with reference to preferred embodiments thereof, it will be understood by those skilled in the art that these and other changes in form and details may be made therein without departing from the spirit and scope of the invention.

What is claimed is:

1. An apparatus comprising:
at least one processor;
a memory coupled to the at least one processor;
a computer program residing in the memory and executed by the at least one processor;
an integrated development environment comprising:
an editor that allows making changes to the computer program; and
an automatic event profile generation mechanism that automatically generates at least one event profile according to the changes made to the computer program using the editor.

2. The apparatus of claim 1 wherein the at least one event profile includes at least one event type specification.

3. The apparatus of claim 1 wherein the at least one event profile includes at least one event filter.

4. The apparatus of claim 1 wherein the integrated development environment further comprises a profiler agent that allows a user to select the at least one event profile when profiling the computer program.

5. The apparatus of claim 1 further comprising a user interface that allows a user to determine how the automatic event profile generation mechanism functions.

6. The apparatus of claim 1 further comprising a profile time mechanism that measures execution time of the computer program to allow comparing current execution time of the computer program with past execution time of the computer program.

7. An apparatus comprising:
at least one processor;
a memory coupled to the at least one processor;
a computer program residing in the memory and executed by the at least one processor;
an integrated development environment comprising:
an editor that allows making changes to the computer program;
an automatic event profile generation mechanism that automatically generates at least one event profile according to the changes made to the computer program using the editor;
a user interface that allows a user to determine how the automatic event profile generation mechanism functions; and
a runtime profiler agent that allows a user to select the at least one event profile when profiling the computer program.

8. The apparatus of claim 7 wherein the at least one event profile includes at least one event type specification.

9. The apparatus of claim 7 wherein the at least one event profile includes at least one event filter.

10. The apparatus of claim 7 further comprising a profile time mechanism that measures execution time of the computer program to allow comparing current execution time of the computer program with past execution time of the computer program.

11. A method for generating an event profile for a computer program, the method comprising the steps of:
(A) editing the computer program; and
(B) automatically generating the event profile according to the edits made in step (A).

12. The method of claim 11 further comprising the steps of:
(C) selecting the event profile for profiling the computer program; and
(D) executing the computer program using the selected event profile.

13. The method of claim 11 wherein the at least one event profile includes at least one event type specification.

14. The method of claim 11 wherein the at least one event profile includes at least one event filter.

15. The method of claim 11 further comprising the step of allowing a user to select the event profile when profiling the computer program.

16. The method of claim 11 further comprising the step of allowing a user to determine how step (B) is performed.

17. The method of claim 11 further comprising the step of measuring execution time of the computer program to allow comparing current execution time of the computer program with past execution time of the computer program.

18. A method for profiling a computer program, the method comprising the steps of:
(A) editing the computer program;
(B) a user setting preferences for the automatic generation of an event profile;
(C) automatically generating the event profile according to the edits made in step (A) and the user preferences set in step (B);
(D) a user selecting the event profile for profiling the computer program; and
(E) executing the computer program using the selected event profile.

19. The method of claim 18 wherein the at least one event profile includes at least one event type specification.

20. The method of claim 18 wherein the at least one event profile includes at least one event filter.

21. The method of claim 18 further comprising the step of measuring execution time of the computer program to allow comparing current execution time of the computer program with past execution time of the computer program.

22. A program product comprising:
(A) an integrated development environment comprising:
(A1) an editor that allows making changes to a computer program; and
(A2) an automatic event profile generation mechanism that automatically generates at least one event profile according to the changes made to the computer program using the editor; and
(B) computer-readable signal bearing media bearing the integrated development environment.

23. The program product of claim 22 wherein the computer-readable signal bearing media comprises recordable media.

24. The program product of claim 22 wherein the computer-readable signal bearing media comprises transmission media.

25. The program product of claim 22 wherein the at least one event profile includes at least one event type specification.

26. The program product of claim 22 wherein the at least one event profile includes at least one event filter.

27. The program product of claim 22 wherein the integrated development environment further comprises a profiler agent that allows a user to select the at least one event profile when profiling the computer program.

28. The program product of claim 22 further comprising a user interface that allows a user to determine how the automatic event profile generation mechanism functions.

29. The program product of claim 22 further comprising a profile time mechanism that measures execution time of the computer program to allow comparing current execution time of the computer program with past execution time of the computer program.

30. A program product comprising:
(A) an integrated development environment comprising:
(A1) an editor that allows making changes to a computer program;
(A2) an automatic event profile generation mechanism that automatically generates at least one event profile according to the changes made to the computer program using the editor;
(A3) a user interface that allows a user to determine how the automatic event profile generation mechanism functions; and
(A4) a runtime profiler agent that allows a user to select the at least one event profile when profiling the computer program; and
(B) computer-readable signal bearing media bearing the integrated development environment.

31. The program product of claim 30 wherein the computer-readable signal bearing media comprises recordable media.

32. The program product of claim 30 wherein the computer-readable signal bearing media comprises transmission media.

33. The program product of claim 30 wherein the at least one event profile includes at least one event type specification.

34. The program product of claim 30 wherein the at least one event profile includes at least one event filter.

35. The program product of claim 30 further comprising a profile time mechanism that measures execution time of the computer program to allow comparing current execution time of the computer program with past execution time of the computer program.
